(19) United States
(12) Patent Application Publication
(10) Pub. No.: US 2008/0277501 A1
(43) Pub. Date: Nov. 13, 2008

(54) Compact solenoid valve

(76) Inventors: William F. Everett, Goshen, IN (US); James R. Thayer, Mishawaka, IN (US)

Correspondence Address: Ryan M. Fountain, Esq., 420 Lincoln Way West, Mishawaka, IN, 46544, US

(21) Appl. No.: 11/801,431

(22) Filed: May 10, 2007

(51) Int. Cl. B65D 83/14; F16K 31/10

(52) U.S. Cl. 239/337; 251/129.15

(57) ABSTRACT

A valve is provided having a solenoid coil in an integrally formed magnetic material having a cross-sectional configuration resembling a bundt pan. Such a structure can be stamp-formed and creates an enlarged surface area available for the magnetic flux to the armature at the bottom of the bundt cross-section. However, since the ends of the stamped structure are not relevant to the magnetic circuit, they can be left unfinished. A thin, flat plate armature and an axial flow valve assembly allows for low friction, low mass movement of the valve seal. Placement of the armature and solenoid across a small air gap provides a high force, very fast response time with minimal electrical power consumption.

### BACKGROUND AND SUMMARY OF THE INVENTION

The present invention relates generally to solenoid valves and to apparatus for automatically dispensing a given quantity of fluid, such as from aerosol cans in a mist format, over an extended period of time.

Solenoid valves generally control the flow of fluid in either liquid or gaseous form between an inlet and an outlet. Such valves have included an armature whose motion was controlled by switching on and off electric current to a coil mounted about a core formed of magnetic material. When the electricity was turned on, for example, the core became magnetized and attracted the armature toward it, thus opening a valve seal operably associated with the armature and allowing fluid to flow through the valve.

The size and spacing of the core, coil, and armature elements determined the speed of actuation, the amount of electrical power needed for actuation and the cost of fabricating the structure. In general, in order to maximize the efficiency of the coil, coils have been wound on separate bobbins and then placed about the core. The core and coil were typically mounted within a separate housing adjacent the armature. Air gaps, multiple components, and spacing in the material of these arrangements tend to reduce the efficiency of the magnetic circuit.

Further, the surface area available to the core for exerting magnetic flux on the armature affects the efficiency of the magnetic circuit. Where air gaps are larger, spacing from the armature is larger, and/or the surface area for magnetic force between the core and armature is smaller, the amount of electrical power and/or the size of the coil needed for actuation is typically larger. However, larger coils tend to have a slower actuation response time because of inductiye reactance when switching the coils on and off.

Accordingly, there have been disadvantages and difficulties in terms of cost of manufacture and operational success in previous attempts at making small solenoid valves, such as of a size that would fit within a conventional aerosol spray can, or similarly sized application, and be operable over an extended period of time on conventional batteries of a consumer acceptable size.

The present invention overcomes the limitations of the prior art in solenoid valves by mounting the solenoid coil in an integrally formed magnetic material having a cross-sectional configuration resembling a bundt pan. Such a structure can be stamp-formed and creates an enlarged surface area available for the magnetic flux to the armature at the bottom of the bundt cross-section. However, since the ends of the stamped structure are not relevant to the magnetic circuit, they can be left unfinished. A thin, flat plate armature and an axial flow valve assembly allows for low friction, low mass movement of the valve seal. Placement of the armature and solenoid across a small air gap provides a high force, very fast response time with minimal electrical power consumption.

The present invention has particular application to aerosol spray cans. Various fluids have long been stored and dispensed in cans under sufficient pressure that as the fluid exits the can through a relatively small orifice it emerges as a mist or spray. Consumers have enjoyed the advantages of such aerosol spray cans for a wide variety of purposes. Such cans typically have an actuator stem at the fluid outlet in the form of a rigid plastic tube. Depressing the actuator stem into the can causes the stored fluid to flow out of the tube and through an orifice attached to the tube to form a spray. A seal within the can typically prevents fluid leakage out of the canister then the tube is not depressed.

It has previously been suggested to attach devices to the actuator stem to allow the can fluid to be automatically and/or remotely dispensed. For example, in public restrooms cans containing deodorants, disinfectants and the like can be periodically actuated to release a desired fluid as a mist during periods of heavy use of the restrooms. These automatic dispensers are, for example, attached to the can actuator stem in place of the normal dispensing orifice and employ solenoid-actuated valves to control release of the canister fluid. Those valves can either be actuated remotely or according to a timed sequence selected by an electrical control device.

Unfortunately, prior automatic dispensers for aerosol cans have been relatively large in size and expensive to manufacture. Reducing the size and costs can create unreliability in fluid sealing and shorten the useful life of the dispenser. Further, prior automatic dispensers have typically required either frequent battery replacement or a remote electric power and/or control source, making installation and maintenance more costly and complicated. Other difficulties that have arisen with prior dispensers include:
installation damage from misalignment of the actuator stem,
impeded fluid flow from installation misalignment of the actuator stem,
excess fluid pressure drop through the dispenser, resulting in less misting of the fluid and more release of the fluid in liquid form (“sputtering” of the spray), and
excess stagnant fluid within the dispenser, resulting, for example, in a greater tendency of the dispenser to clog over time.

The present invention overcomes the limitations of the prior art in aerosol spray can dispensers by installing the above-described compact solenoid inside the can, constructed for high speed actuation, and actuating the spray in shorter bursts, more completely vaporizing the fluid, to dispense spray at a constant pressure rather than as a measured volume. Further, since the compact solenoid is more electrically efficient, for a given application it has a longer service life than prior devices and can be used with a larger can, thus requiring less total propellant expenditure.

### BRIEF DESCRIPTION OF THE DRAWINGS

FIG. 1 shows a top, left perspective view of the present invention as press fit mounted into a conventional aerosol spray can.

FIG. 2 shows an enlarged top, right perspective view of the solenoid valve assembly of the embodiment of FIG. 1.

FIG. 3 shows a further enlarged, partial cross-sectional view of the solenoid valve assembly of FIG. 2

FIG. 4 shows a cross-sectional view of an alternative embodiment of the present invention with a riveted assembly for mounting to the exterior of a can or other containing apparatus.

FIG. 5 shows a cross-sectional view of another alternative embodiment of the present invention in a three way valve application and with a threaded assembly.

FIG. 6 shows a cross-sectional view of yet another alternative embodiment of the present invention in a side ported, multi-way application.

FIG. 7 shows a cross-sectional view of still another alternative embodiment of the present invention in an internally sealed (waterproof) application, with the electrical connections encapsulated in plastic, for example, and the valve functioning with water as the working media.

### DETAILED DESCRIPTION OF PREFERRED EMBODIMENTS

In each of the drawings, like parts are denoted by like numerical indicia. In preferred embodiments, the present invention is actuated by commercially available electrical controls suitable for the intended usage of the dispensing apparatus as a whole, taking into account the size of the apparatus, where it is placed in relation to usage, the intended users, etc. in a conventional manner. Such commercially available controls are not considered part of the claimed invention. Various pulsing controls suitable for the embodiments shown herein are of the type which have been sold by Tri-Tech, LLC of Mishawaka, Ind.

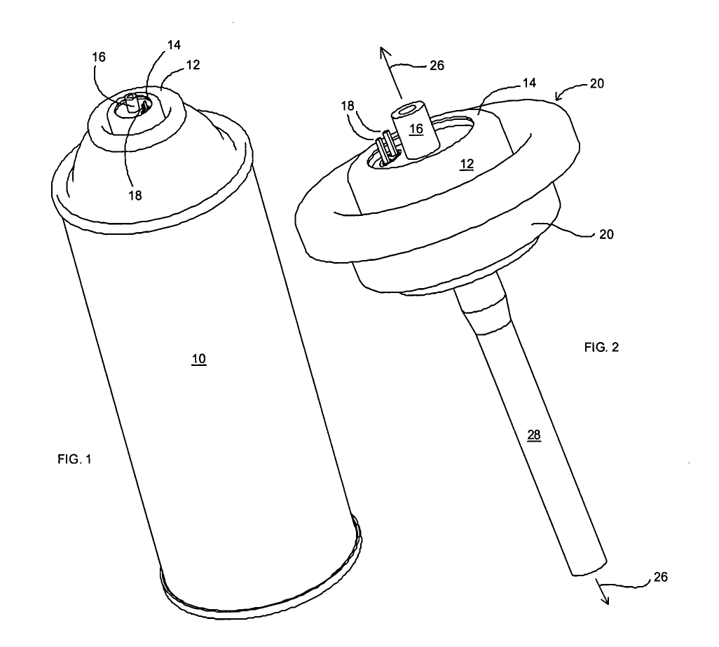

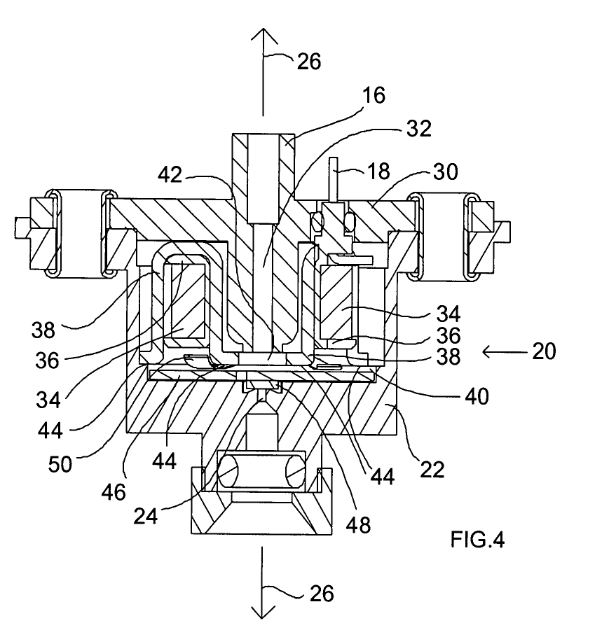

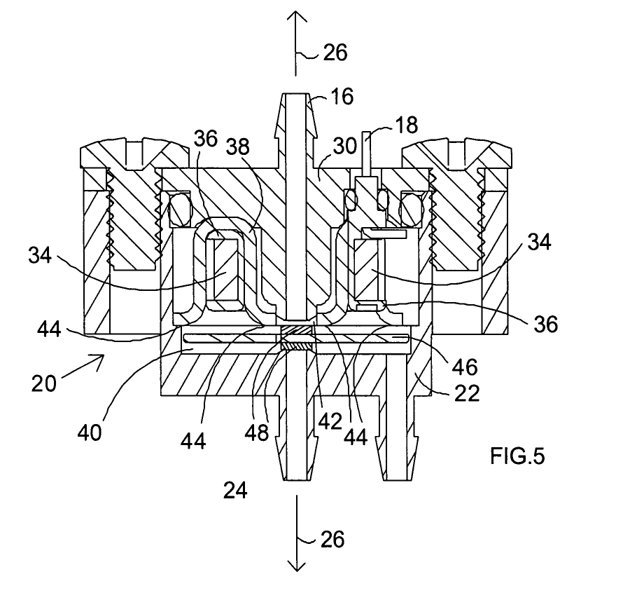

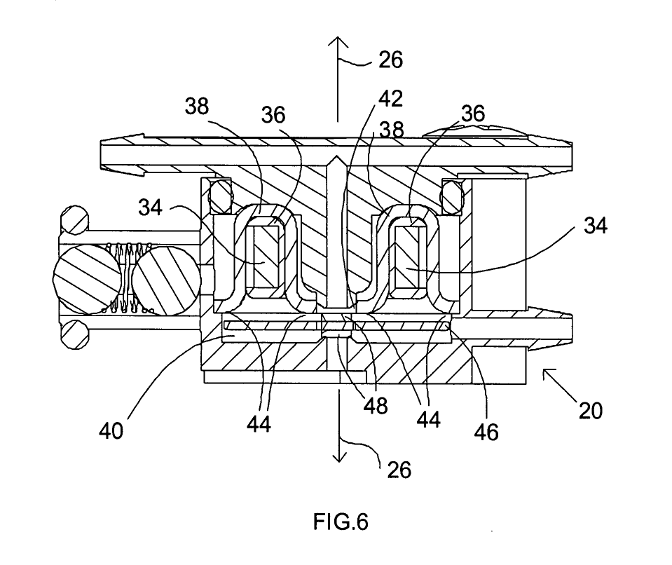

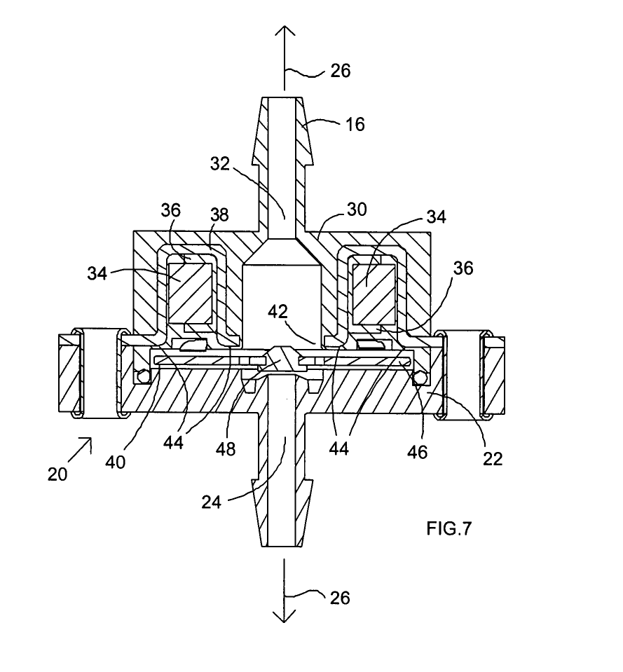

In general, FIGS. 1-3 relate to an internally mounted aerosol can version of the invention. FIG. 4 relates to an additional embodiment of an externally mounted aerosol can where the existing outset stem of the can seats onto the inlet of the invention apparatus, as for example, by an 0-ring seal connection. FIGS. 5 and 6 relate to three way ported valve configurations of the present invention for electro-pneumatic valve and actuator systems, such as could be used in a paint ball gun. FIG. 7 is another variant of the present invention suitable for application with rug cleaning products.

FIG. 1 illustrates the present invention as mounted inside the top portion 12 of a conventional aerosol spray can 10. Assembly 20, containing the solenoid valve of the present invention, is, for example, press fit into top portion 12 and retained by flanges 14. Outlet nozzle 16 extends out from the can and may be of a conventional configuration or direction according to the use of the fluid in the can. Electrical leads 18 also extend out from the can to connect with a conventional or other electrical power source and actuating control device according to the use of the can.

Assembly 20 includes a base 22 having a fluid inlet 24 along flow axis 26. Inlet 24 may, for example, be connected to a conventional stem tube 28 extending toward the interior of can 10. Base 22 is connected to housing 30, with chamber 40 formed between those elements. Housing 30 has a fluid outlet 32 along flow axis 26 which leads to nozzle 16. Wire coil 34 of the solenoid is formed within a bobbin 36 and placed within bobbin cup 38, which is in turn mounted within housing 30 at chamber 40.

Bobbin cup 38 is formed from magnetic material, such as carbon steel, preferably by a stamping process from a single, integrated piece of material. As such, “rounded” corners (as seen in the cross-sectional view) are a characteristic of this configuration, as opposed to squared corners resulting from a machined part. In cross-section, it has a bundt pan configuration with bobbin 36 received within the “cake” fill area of the pan. Bobbin cup 38 has a central aperture 42 aligned with outlet 32 and co-axial with axis 26. Bobbin cup 38 has relatively flat portions 44 at the bottom sides and about aperture 42.

Armature 46 is mounted within chamber 40. This armature is, for example, a thin, flat plate formed from magnetic material, such as carbon steel. Armature 46 is closely spaced from flat portions 44 and may, for example, have opening(s) therein for fluid passage. Armature 46 includes at least one sealing element 48 for engagement with inlet 24. Alternative embodiments allow multiple sealing elements and engagement with either or both of inlet 24 and outlet 32. A flat spring 50, formed from non-magnetic material, is mounted between flat portions 44 and armature 46 in preferred embodiments so as to bias sealing element 48 to close the flow of fluid from inlet 24. However, in alternative embodiments that arrangement can be reverse for open biasing or, in some applications, no spring element may be needed.

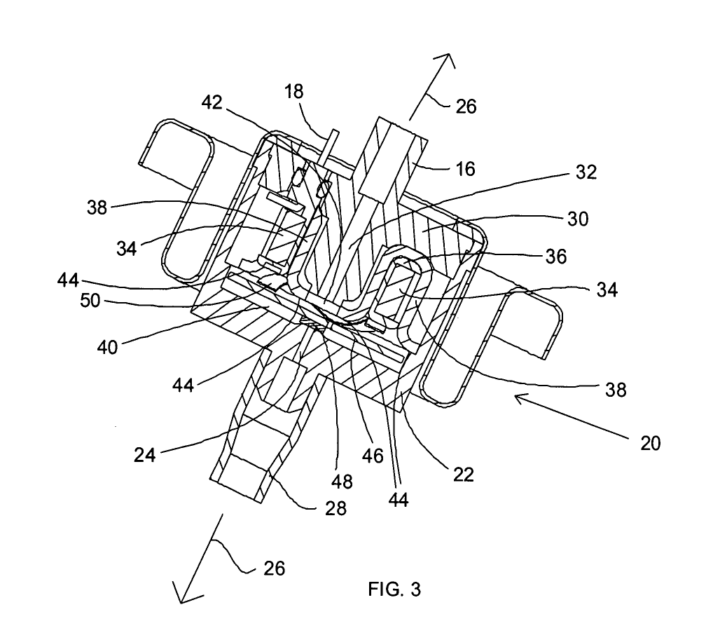

Operation of the present invention will now be readily understood by those skilled in the art. With the embodiment of FIG. 3, for example, electrical actuation of coil 34 by commercially available pulsing controls will create a magnetic field through flats 44 which exerts an attractive force on armature 46 that overcomes the biasing of spring 50 and moves the armature toward flats 44, thus opening the flow of fluid from inlet 24. That electrical actuation can be controlled or occur at any desired time or subject to any desired interval or other criterion, according to conventional devices, and can be arranged to be controlled remotely. Since Bobbin cup 38 is a single, integral part, armature 46 is of low mass, the gap between flats 44 and armature 46 is small, and there is a relatively large surface area for the magnetic force to be applied to, less electrical energy is needed for actuation and the response time for actuation is shorter than with prior devices. Thus, smaller components may be used effectively with less electrical supply requirements, facilitating placement within the can and use of conventional electrical batteries or solar power sources.

While the present invention has been described above in detail with respect to particular preferred embodiments, this was by way of illustration and example only. The present invention is applicable to many different uses, as demonstrated by the alternative embodiments of the drawings and described above. In general, any structural means equivalent to the embodiments above for achieving a similar functional result is considered within the spirit and scope of the present invention. For example, in various applications the working fluid can be air (or another gaseous material) or a liquid (such as water). The working fluid can be used to entrain another, dispensed fluid or can itself be the dispensed fluid. Accordingly, the invention is limited only by the terms of the following claims and any claims in related patents.

What is claimed is:

1. An electromagnetically actuated valve, comprising:
an inlet,
an outlet,
an enlarged chamber between the inlet and outlet
a plate armature mounted within the chamber with sealing means thereon for controlling fluid flow between the inlet and the outlet,
solenoid means mounted within the chamber and closely spaced from the armature, and
the solenoid means having its coil element mounted within a magnet material formed in a bundt pan cross-section.

2. The valve according to claim 1 wherein the inlet and outlet have a common axis of fluid flow therethrough.

3. The valve according to claim 2 wherein the central aperture of the magnetic material is aligned with the common axis.

4. The valve according to claim 3 wherein the armature is formed as a flat plate of a minimal thickness.

5. The valve according to claim 4 wherein the actuation motion of the armature is along the common axis.

6. The valve according to claim 3 wherein the coil element is mounted within the fill portion of the bundt pan cross section and the bottom flats form the magnetic surface area for attraction of the armature during valve actuation.

7. The valve according to claim 6 wherein the magnetic material is formed from a single, stamped element.

8. The valve according to claim 7 mounted inside an aerosol spray can at the outlet thereto so as to control spray dispensing.

9. The valve according to claim 8 wherein a spring is mounted between the armature and the magnetic material to bias sealing means to close the flow of fluid to the outlet.

10. An aerosol spray can having an electromagnetically operated dispensing valve mounted therein for automatically spraying fluid from the can.
